(19) United States
(12) Patent Application Publication
(10) Pub. No.: US 2007/0039969 A1
(43) Pub. Date: Feb. 22, 2007

(54) Straight-sided thermos

(76) Inventor: Elizabeth Pittis-Moffitt, Ocean Grove, NJ (US)

Correspondence Address: Charles I. Brodsky, Esq., 2 Bucks Lane, Marlboro, NJ, 07746, US

(21) Appl. No.: 11/207,416

(22) Filed: Aug. 22, 2005

(51) Int. Cl. A47J 41/00

(52) U.S. Cl. 220/592.27

(57) ABSTRACT

A heat retentive food container including a vacuum-sealed base section and a vacuum-sealed cover section of linear, non-circular configuration, and of a dimension to store and keep warm, hot or cold solid and liquid foods placed in the cavity formed thereby.

### CROSS-REFERENCE TO RELATED APPLICATIONS

NONE

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to heat retentive food containers, in general, and to a straight-sided thermos dewar, vacuum bottles to store and keep warm, hot and cold solid and liquid foods, in particular.

2. Description of the Related Art

As will be appreciated, there exist a great number of design constructions proposed in the past for transporting foods and keeping them either warm or cool in the process. Typical of these are those as follows:

1. U.S. Design Pat. No. 472,107 shows an ornamental arrangement for a food jar.

2. U.S. Design Pat. No. 474,377 shows an ornamental design for a food jar and lid.

3. U.S. Pat. No. 2,746,634 shows a sectional thermos food container suitable for holding two or three liquids, and additional space for solid foods. As is set forth at the top of Column 2, various caps can be unscrewed for pouring out individual contents, and by unscrewing the case, all the compartments may be removed independently.

4. U.S. Pat. No. 3,854,023 shows a container to allow heating of food in a microwave oven. The construction is said to allow two or more dinners to be cooked simultaneously all at the same time, instead of taking twice the time to cook one dinner or three times the time to cook three dinners.

5. U.S. Pat. No. 4,081,646 illustrates another device for microwave cooking in which control can be had of the exposure to the microwave heating of all ingredients at the same time, rather than to face a possibility of different quantities of microwave energy to be employed in the heating of different sectionalized meals. The construction is said to allow dealing with situations where some of the foods to be subjected to the microwave energy have been precooked and then frozen or refrigerated, while others may have been undercooked—with the invention allowing to heat both foods to their intended serving temperatures at the same time.

6. U.S. Pat. No. 4,969,558 is concerned with a lunch box construction for microwave use which utilizes a non-metallic lid designed for spacing chambers to accept heat during the microwave use.

7. U.S. Pat. No. 5,052,369 describes food containers of different shapes and sizes employing sealed internal chambers with micro-crystalline wax for the keeping of food warm, especially when placed in a microwave or conventional convection oven. The invention specifically relates to the construction of the food cover using various plastics and chemicals injection molded, extruded, or otherwise arranged in allowing its employment for use as a food container in a configuration of a soup bowl, beverage cup or plate.

8. U.S. Pat. No. 5,082,115 describes a lunch box container having a removably mounted, thermally insulated liquid container along with a base member to carry a full meal of different foods. Dividers are provided for separating the base into compartments for receiving different foods, and also to separate utensils included within the container itself. The invention sets out the container construction to be one which is easily portable and economically manufacturable. The essence of the invention is more clearly set forth at Column 2, Line 9, in a construction which permits dividing the base into two or more spaces for food separation.

9. U.S. Pat. No. 5,257,509 describes a briefcase construction which can be used not only as a briefcase, but as a compartment for storing and transporting hot and cold foods and beverages. The design is said to allow conversion of the briefcase into a mini-cooler for other drink beverages.

10. U.S. Pat. No. 5,325,969 describes a lunch pail or lunch box with an upper member for containing a first food or beverage, and a second compartment for containing a different type of food in the nature of a plate lunch. The two compartments are separable so that several meals may be prepared in advance and placed in individual inserts, to be stored and then, where desired, placed in a microwave oven for preparing the plate lunch.

11. U.S. Pat. No. 5,501,338 shows a carry bag container having stacked, interchangeable rigid food tray assemblies. Insulated covers are employed to keep a first series of foods refrigerated, and others to keep them warm against thermal loss. The design allows for the stacking of food trays, and then securing them together by a strap for transportation.

12. U.S. Pat. No. 5,520,103 describes the use of a heat storage medium able to change from a solid to a gelatinous state when heated for storing temperatures needed to keep food warm. When it cools, the medium changes back to a solid in maintaining the food at the elevated temperature desired.

13. U.S. Pat. No. 5,876,811 describes, once again, the microwaving of meals, this time for a single-serving portion. To accomplish this, a microwave polyurethane foam shell is employed and vacuum seals are provided in different portions of the construction.

14. U.S. Pat. No. 6,149,005 is a container and strap combination for food services in transporting pre-cooked and packaged foods. The inside of the container includes a plurality of spaces and wells for holding food, drinks and cutlery. The illustrated construction also includes straps closing the container and to allow for lifting and carrying of it about. The individual cavities and wells may be of different size, and/or different shape.

15. U.S. Pat. No. 6,269,964 describes a food container construction for microwave use including a plurality of removable, microwavable compartments. The compartments are designed to fit over a base in allowing for the easing of removing the individual compartments. The Patent asserts that the food container as an entity is microwavable, as are the individual compartments which can be separately removed. In this manner, food which is to be eaten cold can be removed without microwaving, while those foods that are to be eaten hot can be removed and microwaved as a separate entity.

16. Patent Application No. 2002/0084206 illustrates a lunch box having separable food tray assemblies to keep varieties of food stuffs segregated and separate from one another, in easily hinged manner for organizing food and beverage leftovers, in particular.

17. Patent Application No. 2004/0149620 describes a configuration for carrying hot dogs, frankfurters, sausages, corn dogs and bratwurst while keeping them warm and separated one from another, especially where they are precooked. A handle is provided and a cover can be locked in place with the handle, with further cavities being provided in the trays to receive condiments, as desired.

Vacuum flask thermos bottles, on the other hand, are designed cylindrically shaped for keeping such liquids as coffee, tea, hot chocolate and soups warm, and for keeping such liquids as soda, water, beer and wine cold. Constructed with a “round” opening through which the liquid is poured in, or poured out, such flasks—no matter how wide they have been—are not generally usable where “food” is to be kept hot or cold. While someone may be able to stuff chicken wings, or chili, or macaroni-and-cheese into the narrow openings of the vacuum flask, the designs are difficult to later scoop them out completely, or otherwise retrieve them.

### SUMMARY OF THE INVENTION

The present invention envisions these vacuum flasks as being of non-cylindrical, straight-sided shapes in the nature of triangular, rectangular, square, or like parallelogram shapes, of whatever depth may be desired. The hot or cold food could be prepared initially, and placed in the vacuum container to be removed and eaten at a picnic, at a ski lodge, or in a schoolroom for children bringing, in this manner, healthier foods than could otherwise be purchased in the school cafeteria.

The present invention is directed to such a flask which has a lid which allows the storage of these foods, which could then be closed over and secured until ready to be eaten at a later time. The thermos then comprises a non-cylindrically shaped vacuum flask.

As will be more particularly described, the present invention thus includes a vacuum-sealed base section, a vacuum-sealed cover section forming a cavity for food retention when closed atop the base section; and with each of the base and cover sections being of linear, non-circular configuration to store and keep warm solid and liquid foods stored within. As will also be seen, in a preferred embodiment of the invention, the heat retentive food container could have all combinations of a substantially non-slip surface on an underside of the base section for restraining movement of the food container when placed on a flat surface, a substantially non-slip surface on opposing side surfaces of said base section for supporting holding of the food container when lifted from a flat surface, and with a substantially non-slip surface on opposing side surfaces of the cover section for easing removal of the cover section from the base section in the opening and closing of the container. Of preferable rectangular configuration, the food container could be of a type in which the base and cover sections could be hinged together—but in the preferred embodiment of the invention, are removably joined instead for the closing and opening of the internal cavity of the container by a latch system employing a clasp and tab releasable securement. Pairs of clamps and tabs extending from correspondingly facing side surfaces of the base and cover sections may be employed in this respect, to facilitate the engagement/disengagement of the base and cover sections for the hot solid and liquid foods stored within.

### BRIEF DESCRIPTION OF THE DRAWINGS

These and other features of the present invention will be more clearly understood from a consideration of the following description, taken in connection with the accompanying drawings, in which:

FIG. 1 is a perspective view of a straight-sided thermos, heat retentive food container embodying the principles of the present invention;

FIG. 2 is a disassembled view of the base and cover sections which form the food container of FIG. 1 when joined together;

FIG. 3 are head-on views of the base and cover sections of FIG. 2;

FIG. 4 is a head-on view of the food container of FIG. 1 in its closed condition;

FIG. 5 is a bottom view of the base section and closed food container of FIG. 1; and

FIG. 6 is a tail-end view of the food container of FIG. 1.

### DETAILED DESCRIPTION OF THE INVENTION

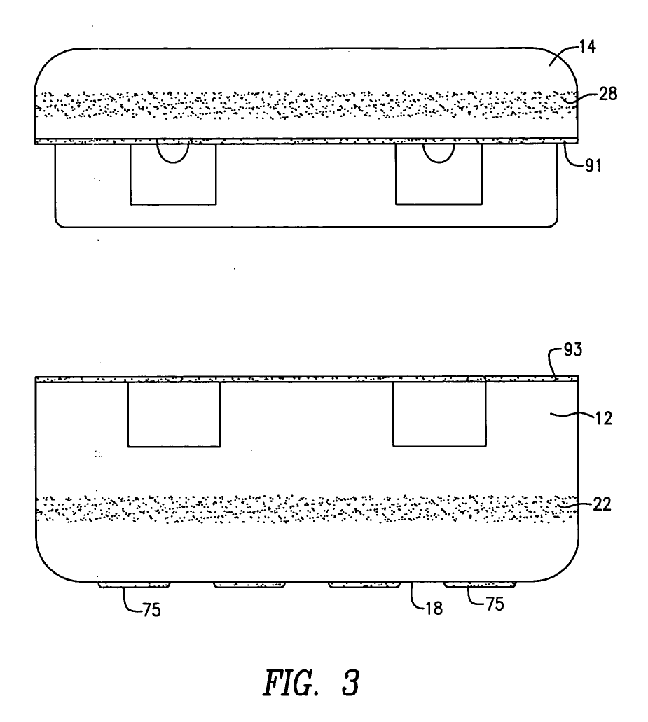

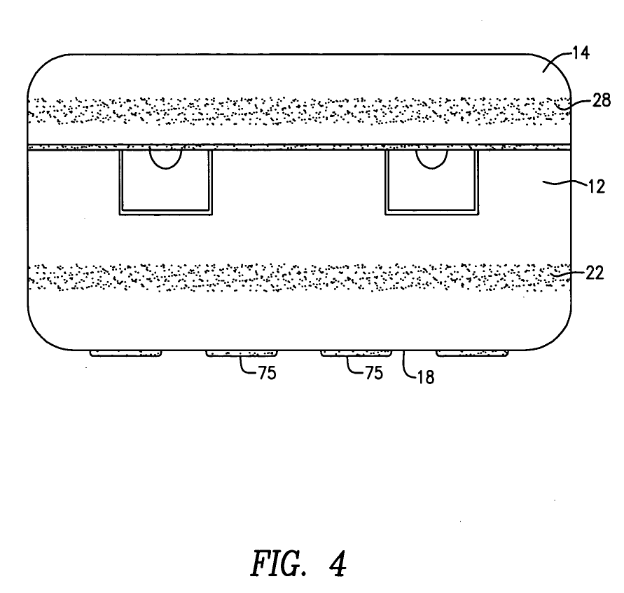

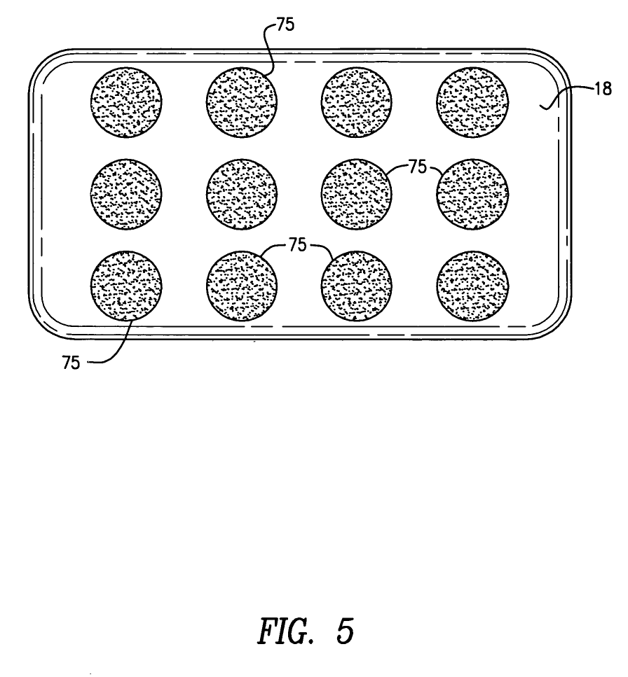

Referring to the Drawings, the heat retentive food container 10 is shown as having a vacuum-sealed base section 12 and a vacuum-sealed cover section 14, each being of linear, non-circular configuration. When closed together, a cavity 16 in the base section 12 is provided in which solid and liquid foods may be stored and kept warm. As more clearly shown in FIGS. 3-5 a substantially non-slip surface is included on an underside 18 of the base section 12 for restraining movement of the container 10 when placed on a flat surface. As FIGS. 3-5 illustrate, this substantially non-slip surface may be in the form of a series of non-skid disks 75 of any appropriate material to provide a degree of friction for any accidental motion.

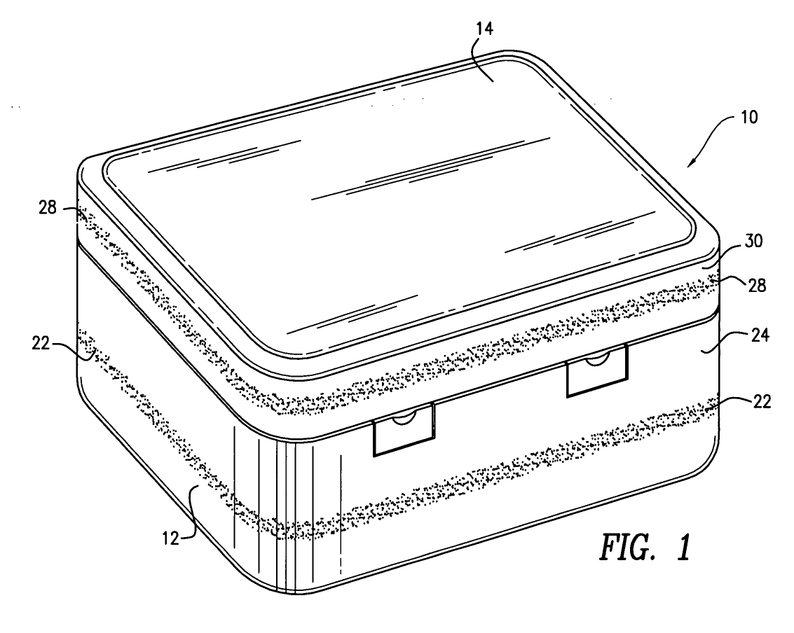

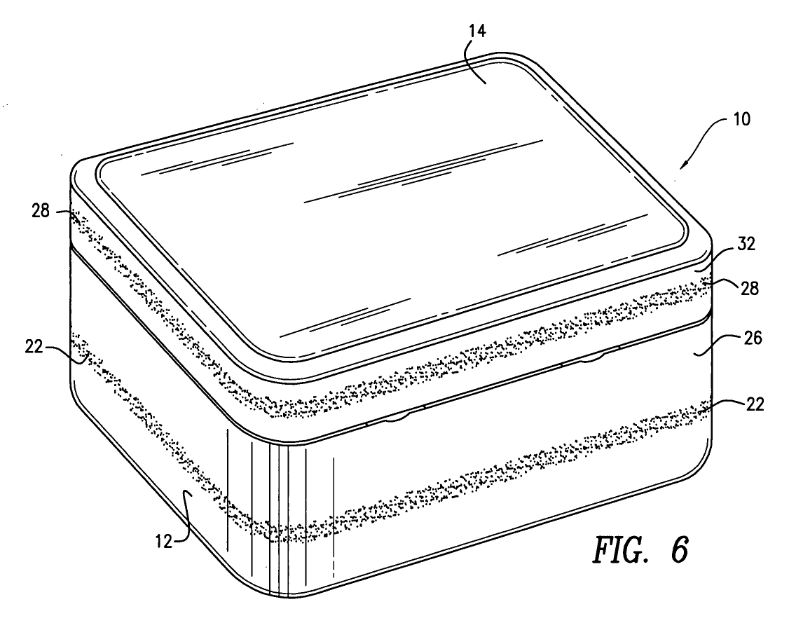

FIGS. 1-4 and 6 also illustrate the food container 10 having a substantially non-slip surface 22 on opposing side surfaces (as 24, 26) of the base section 12 for supporting the holding of the container 10 when lifted from the flat surface. FIGS. 1-4 additionally illustrate a substantially non-slip surface 28 on opposing side surfaces (as 30, 32) of the cover section 14 for easing removal of the cover section 14 from the base section 12 in the opening and closing of the container. Although the food container of the invention may be of triangular, rectangular, square, or like parallelogram shape, the rectangular configuration of FIGS. 1-6 is to be preferred.

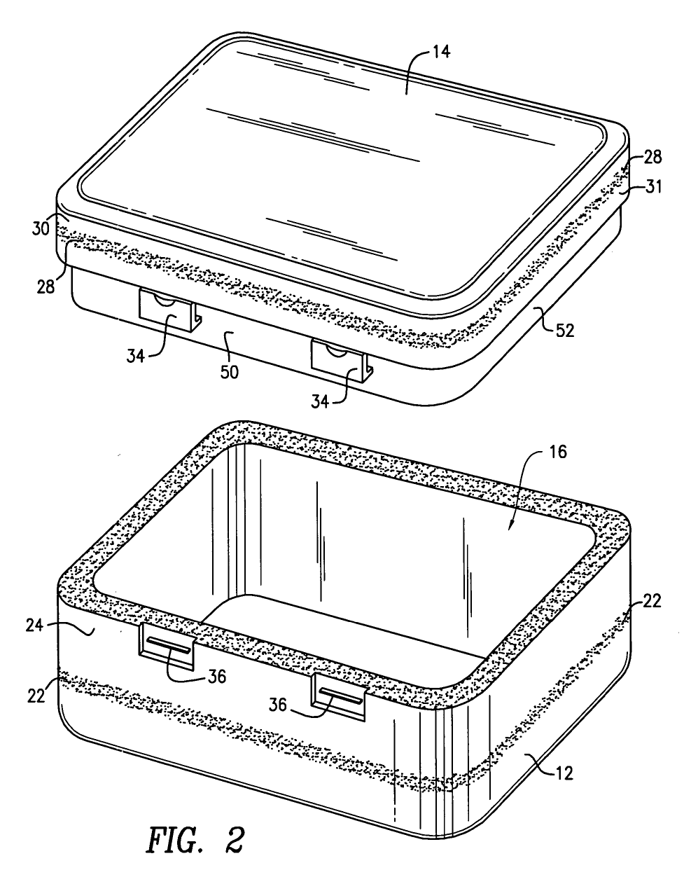

The base section 12 and cover section 14 of the food container 10 may be hinged together for opening and closing—but in the preferred embodiment of the invention, are removably joined together by a latch system employing a clasp and tab releasable mount. As more clearly seen in FIGS. 2 and 3, individual pairs of clasps 34 and tabs 36 are illustrated extending from correspondingly facing side surfaces (24, 50) in removably joining the base and cover sections together. To effectuate any non-leaking, thermal join between the two sections 12, 14, the cover section 14 is arranged to have first and second sets of surrounding side surfaces (30, 31 on the one hand, and 50, 52 on the other hand), with the first set of surfaces 30, 31 overlying the second set of surfaces 50, 52—such that the second set 50, 52 align the clasps 34 to removably join with the base section tabs 36 for the releasable securement. Gasket seals 91 and 93 are understood as being included at the underside of the cover section 14 and the base section 12 to prevent leakage of the thermos when closed (FIG. 3).

As will be appreciated by those skilled in the art, the non-slip surface at the underside 18 of the base section 12 allows the straight-sided thermos to be set down, to remain in place. With the non-slip surface 28 on the cover section 14, the cover could be easily removed and replaced as a lid. With the non-slip surface 22, it becomes easier for the lid to then be removed-by similarly holding on to each of their respective non-slip surfaces; and, once the lid is removed, the non-slip surface 22 provides an easy manner of grasping the base section 12 to either drink from the cavity 16 or eat from the solid food stored therein. By employing the base and cover sections 12, 14 of a vacuum-sealed construction, the solid and/or liquid foods stored therein can be kept warm.

While there have been described what are considered to be preferred embodiments of the present invention, it will be readily appreciated by those skilled in the art that modifications can be made without departing from the scope of the teachings herein. For example, fixed partitions may be provided internal of the cavity 16 for separating one hot food from another—or various clips can be affixed to the inside walls defining the cavity to receive removable partitions in separating one food from another. Also, while spanning the opposing side surfaces of the cover section 14 to remove its lid or spanning the opposing side surfaces of the base section 12 to hold the container can be accomplished by a grasping action of the hand where the container is of a small or medium size, only adjacent side surfaces might be able to be grasped where the container is larger. Recognizing that the non-slip surfaces 22 and 28 go around the edge surfaces of the straight-sided thermos of the invention, it is to be understood that the words “opposing side surfaces” in the claims also encompass the “adjacent side surfaces” of the container, and are to be read in this context. And, at the same time, while the teachings of the present invention are particularly attractive in keeping solid and liquid foods warm or hot, the teachings of the invention will be understood to be equally applicable as well for the keeping of solid and liquid foods cold by the inherent nature of the vacuum-sealing provided. For at least such reasons, therefore, resort should be had to the claims appended hereto for a true understanding of the scope of the invention.

I claim:

1. A heat retentive food container comprising:
a vacuum-sealed base section; and
a vacuum-sealed cover section forming a cavity for food retention when closed atop said base section;
with each of said base and cover sections being of linear, non-circular configuration to store and keep warm solid and liquid foods stored within.

2. The food container of claim 1, with a substantially non-slip surface on an underside of said base section for restraining movement of said container when placed on a flat surface.

3. The food container of claim 1, with a substantially non-slip surface on opposing side surfaces of said base section for supporting holding of said container when lifted from a flat surface.

4. The food container of claim 2, with a substantially non-slip surface on opposing side surfaces of said base section for supporting holding of said container when lifted from a flat surface.

5. The food container of claim 1, with a substantially non-slip surface on opposing side surfaces of said cover section for easing removal of said cover section from said base section in the opening and closing of said container.

6. The food container of claim 2, with a substantially non-slip surface on opposing side surfaces of said cover section for easing removal of said cover section from said base section in the opening and closing of said container.

7. The food container of claim 1, with each of said base and cover sections being of rectangular configuration.

8. The food container of claim 2, with each of said base and cover sections being of rectangular configuration.

9. The food container of claim 1, with a substantially non-slip surface on opposing side surfaces of said base section for supporting holding of said container when lifted from a flat surface, with a substantially non-slip surface on opposing side surfaces of said cover section for easing removal of said cover section from said base section in the opening and closing of said container, and with each of said base and cover sections being of rectangular configuration.

10. The food container of claim 9, with a substantially non-slip surface on an underside of said base section for restraining movement of said container when placed on a flat surface.

11. The food container of claim 8, wherein said base section and said cover section are removably joined together in the closing and opening of said cavity by a latch system employing a clasp and tab releasable securement.

12. The food container of claim 11 utilizing individual pairs of clasps and tabs extending from correspondingly facing side surfaces of said base and cover sections in removably joining said sections together.

13. The food container of claim 11, wherein said cover section includes first and second sets of surrounding side surface of rectangular configuration, with said first set overlying said second set, and with said second set removably joining with said base section via said clasp and tab releasable securement.

14. The food container of claim 12, with a substantially non-slip surface on opposing side surfaces of said first set of surrounding side surfaces for easing removal of said cover section from said base section in the opening and closing of said container.

15. The food container of claim 14, with a substantially non-slip surface on opposing side surfaces of said base section for supporting holding of said container when lifted from a flat surface.
